(19) United States
(12) Patent Application Publication
(10) Pub. No.: US 2012/0229460 A1
(43) Pub. Date: Sep. 13, 2012

(54) Method and System for Optimizing Resource Usage in a Graphics Pipeline

(75) Inventor: Etienne Fortin, Saint-Bruno-de-Montarville (CA)

(73) Assignee: SENSIO TECHNOLOGIES INC., Montreal (CA)

(21) Appl. No.: 13/416,217

(22) Filed: Mar. 9, 2012

Related U.S. Application Data
(60) Provisional application No. 61/452,085, filed on Mar. 12, 2011.

(51) Int. Cl. G06T 15/00; G06T 1/00

(52) U.S. Cl. 345/419; 345/501

(57) ABSTRACT

Method and system for optimizing resource usage in a graphics pipeline. The graphics pipeline renders pixels of a two-dimensional image on a basis of at least one model and outputs a stream of image frames characterized by a frame rate, a resolution and a level of detail. If the format in which the frames will be output from the graphics pipeline is characterized by pixel omission, the plurality of pixels removed from the frames prior to their output from the graphics pipeline according to the format are identified, and the graphics pipeline is configured to only render pixels other than the plurality of pixels that will be removed. Accordingly, it may be possible to reassign resources of the graphics pipeline from pixel rendering-related operations to other processing operations, thus optimizing resource usage and allowing for an improved performance by the graphics pipeline.

### TECHNICAL FIELD

This invention relates generally to the field of three-dimensional computer graphics and more specifically to a method and system for optimizing resource usage in a graphics pipeline.

### BACKGROUND

In three-dimensional (3D) computer graphics, the term graphics pipeline (also referred to as a rendering pipeline) is commonly used to refer to a system of graphics hardware and software that is designed to generate (or render) a two-dimensional image from one or more models. The rendering is based on three-dimensional objects, geometry, viewpoint, texture, lighting and shading information describing a virtual scene. Thus, in one example, the graphics pipeline of a rendering device, such as a graphics processing unit (GPU), handles the conversion of a stored 3D representation into a two-dimensional (2D) image or view for display on a screen.

A typical graphics pipeline includes several different stages, including an application stage, a geometry stage and a rasterizer stage. The pipeline stages may execute in parallel, which increases the performance of the rendering operation; however, the rendering speed (also referred to as the pipeline throughput or the update rate of the images) is limited by the slowest stage in the pipeline.

The application stage is driven by an application (e.g. a simulated 3D graphics application or an interactive computer aided design (CAD) application) and is implemented in software running on general-purpose CPUs, such that it is fully controlled by the developer of the application. Tasks performed on a CPU during the application stage depend on the particular type of application and may include collision detection, global acceleration algorithms, animation and physics simulation, among many others. The application stage outputs rendering primitives, i.e. points, lines and polygons that may end up being displayed on an output device, which are fed to the geometry stage.

The geometry stage, which computes what is to be drawn, how it should be drawn and where it should be drawn, is typically implemented on a GPU containing many programmable cores as well as fixed-operation hardware. The geometry stage is responsible for most of the per-polygon and per-vertex operations, where a polygon is a two-dimensional shape that is modeled, stored in a database and referenced as needed to create a scene that is to be drawn. A polygon's position in the database is defined by the coordinates of its vertices (corners), and it can be coloured, shaded and textured to render it in the correct perspective for the scene that is being created. Although the polygons are two-dimensional, they can be positioned in a visual scene in the correct three-dimensional orientation so that, as a viewing point moves through the scene, it is perceived in 3D. The geometry stage is divided into several well known functional sub-stages that process the polygons and vertices of the image, including model and view transform, vertex shading, projection, clipping and screen mapping.

The rasterizer stage, which may also be implemented on a GPU, draws (or renders) a 2D image on the basis of the data generated by the geometry stage, where this data includes transformed and projected vertices with their associated shading data. The goal of the rasterizer stage is to compute and set colors for the pixels associated to the objects in the image. Similar to the geometry stage, the rasterizer stage is divided into several well known functional stages, including triangle setup, triangle transversal, pixel shading and merging. When the primitives generated by the application stage have passed the rasterizer stage, those that are visible from the viewpoint (of a virtual camera) are displayed on screen.

Each of these stages of the graphics pipeline makes use of various memory and processing resources that are available to the graphics pipeline in order to implement its respective functions. The processing resources may include functional units of a graphics card or GPU (e.g. parallel processing units), dedicated processing units, graphics acceleration hardware, custom software programs, etc. Since each processing resource has a maximum processing capacity, resource usage by the graphics pipeline is limited and the performance of the graphics pipeline is restricted by this limit.

In real-time rendering applications, such as animated movies or video games, the rate at which the images are displayed to a viewer determines the sense of interactivity and animation fluidity experienced by the viewer, such that the applications strive for higher display rates. The time taken by an application to generate an image is dependent on the rendering speed of the graphics pipeline, which itself may vary depending on the complexity of the computations performed during each frame.

Real-time rendering applications are also concerned with the resolution of the rendered images (i.e. the total number of pixels in the rendered image). The greater the resolution of a rendered image, the greater the number of pixels that must be rendered or drawn by the graphics pipeline. Furthermore, the number of polygons drawn per frame by the graphics pipeline when rendering an image determines the level of detail that the rendered image holds. The greater the number of polygons drawn per frame by the graphics pipeline, the greater the image detail.

Since a graphics pipeline has a limited number of available processing resources, an inversely proportional relationship exists between the frame rate (or display rate) and the resolution supported by the graphics pipeline. More specifically, given its available resources, a graphics pipeline is capable to handle a certain complexity of processing operations, where this processing includes drawing a predefined number of polygons per rendered frame of an image. Given this processing complexity, the graphics pipeline may be set to support a higher frame rate and a lower resolution or, alternatively, a higher resolution and a lower frame rate. In other words, if the graphics pipeline has less pixels to render per image, the graphics pipeline can display the rendered images at a faster rate. The greater the number of pixels to be rendered per image, the slower the rate at which the graphics pipeline can display the rendered images.

Furthermore, in the same way that both the resolution and frame rate of a graphics pipeline can affect the processing resource usage within the pipeline, the number of polygons to be drawn per frame by the graphics pipeline is also a drain on the available processing resources. Thus, in order for the graphics pipeline to be able to display rendered images at a particular resolution, it may be necessary to adjust either the display rate or the complexity of the processing performed per rendered frame, since the limited processing resources available to the graphics pipeline impose constraints on the performance of the graphics pipeline. More specifically, by reducing either the frame rate or the number of polygons drawn per rendered frame, the graphics pipeline may be able to support a higher resolution.

It is clear that, in terms of the performance of a graphics pipeline, the limits of the processing resources available to the graphics pipeline create a necessary trade-off between the throughput speed (i.e. display rate), the resolution of the rendered images and the level of detail in the rendered images. Unfortunately, these parameter trade-offs may result in a loss of image quality as perceived by a viewer to whom the rendered images are being displayed.

In addition, the performance limits imposed on a graphics pipeline by its processing resources make it difficult to use such a graphics pipeline for more complicated rendering operations (e.g. operations requiring complex computations and/or a high number of polygons to be drawn per pixel) without sacrificing the frame rate or the quality of the rendered graphics. For example, in a traditional simulated 3D graphics environment, such as the Computer-Generated Imagery (CGI) used in video games, the graphics pipeline of a game engine renders a 2D view (or image) using assets and knowledge of the position and orientation of the virtual “camera” viewing the world. More specifically, the graphics pipeline generates a single sequence of frames on the basis of this view. Today, stereoscopic displays are becoming available and stereoscopic viewing modes are increasingly being demanded or required in simulated 3D graphic applications. However, providing a stereoscopic viewing mode requires the generation of two images rather than just one, which requires double the processing time by the graphics pipeline and thus a reduction by half of the frame rate, resolution or level of detail (number of polygons drawn) supported by the graphics pipeline. Accordingly, when the graphics pipeline is tasked with the more burdensome operations associated with the parallel rendering of two separate frame sequences, it often results in an undesirable quality trade-off.

A need therefore exists in the industry for a method and system to optimize resource usage within a graphics pipeline, such that the standard parameter trade-offs inherent to the graphics pipeline neither diminish the quality of the rendered images output by the graphics pipeline nor prevent the implementation of more complex processing operations.

### SUMMARY

In accordance with a broad embodiment, there is provided a method of optimizing resource usage in a graphics pipeline, the graphics pipeline operative to render pixels of a two-dimensional image on a basis of at least one model and to output a stream of image frames characterized by an output frame format, a frame rate, a resolution and a level of detail. If the output frame format is characterized by pixel omission, the method includes identifying a plurality of pixels removed from the frames prior to their output from the graphics pipeline according to the format; and configuring the graphics pipeline to only render for each frame pixels other than the plurality of pixels.

In accordance with another broad embodiment, there is provided an image generation system for rendering two-dimensional images, the system comprising at least one input for receiving data representative of a three-dimensional scene and a graphics pipeline operative to process the data and to render pixels of a two-dimensional image. The graphics pipeline outputs a stream of image frames in a particular format and characterized by a frame rate, a resolution and a level of detail. If the particular format is characterized by pixel omission, the system is operative to identify a plurality of pixels removed from the frames prior to their output from the graphics pipeline according to the particular format, and to configure the graphics pipeline to only render for each frame pixels other than the plurality of pixels.

In accordance with yet another broad embodiment, there is provided a method for outputting a stream of image frames in a merged frame format, the merged frame format being characterized by a merging together of a pair of frames, the merging including omission of a plurality of pixels from each frame. The method includes identifying a first plurality of pixels omitted from a first frame and a second plurality of pixels omitted from a second frame according to the merged frame format; selecting first and second sets of pixels to render for the first and second frames, respectively, the first set of pixels excluding the first plurality of pixels, the second set of pixels excluding the second plurality of pixels; generating the first frame by rendering only the first set of pixels and generating the second frame by rendering only the second set of pixels; merging the first and second frames into a third frame on a basis of the merged frame format; and outputting the third frame in a stream of image frames.

### BRIEF DESCRIPTION OF THE DRAWINGS

The invention will be better understood by way of the following detailed description of embodiments of the invention with reference to the appended drawings, in which:

FIG. 1 illustrates a simplified functional breakdown of a graphics pipeline;

FIG. 2 is a conceptual illustration of an example of 2D image generation by a graphics pipeline;

FIG. 3 is a conceptual illustration of a first solution for dual stream generation by a graphics pipeline;

FIG. 4 is a conceptual illustration of a second solution for dual stream generation by a graphics pipeline;

FIG. 5 is a flow diagram illustrating the process implemented by a graphics processing entity, according to a non-limiting embodiment;

FIG. 6 is a conceptual illustration of a 2D image generation system, according to a non-limiting embodiment;

FIG. 7A is an example of a pair of original image frames of a high definition video stream;

FIGS. 7B and 7C illustrate quincunx sampling, horizontal collapsing and merging together of the two frames of FIG. 7A, according to a non-limiting example of implementation;

FIG. 8 is a conceptual illustration of a 2D image generation system, according to a variant embodiment;

FIG. 9 is a simplified comparison of the operations of a graphics card implementing the 2D image generation system of FIG. 6 and the operations of a graphics card implementing the 2D image generation system of FIG. 8; and

FIG. 10 illustrates an exemplary graphical user interface allowing a user to input data to an image generation system, according to an embodiment.

### DETAILED DESCRIPTION

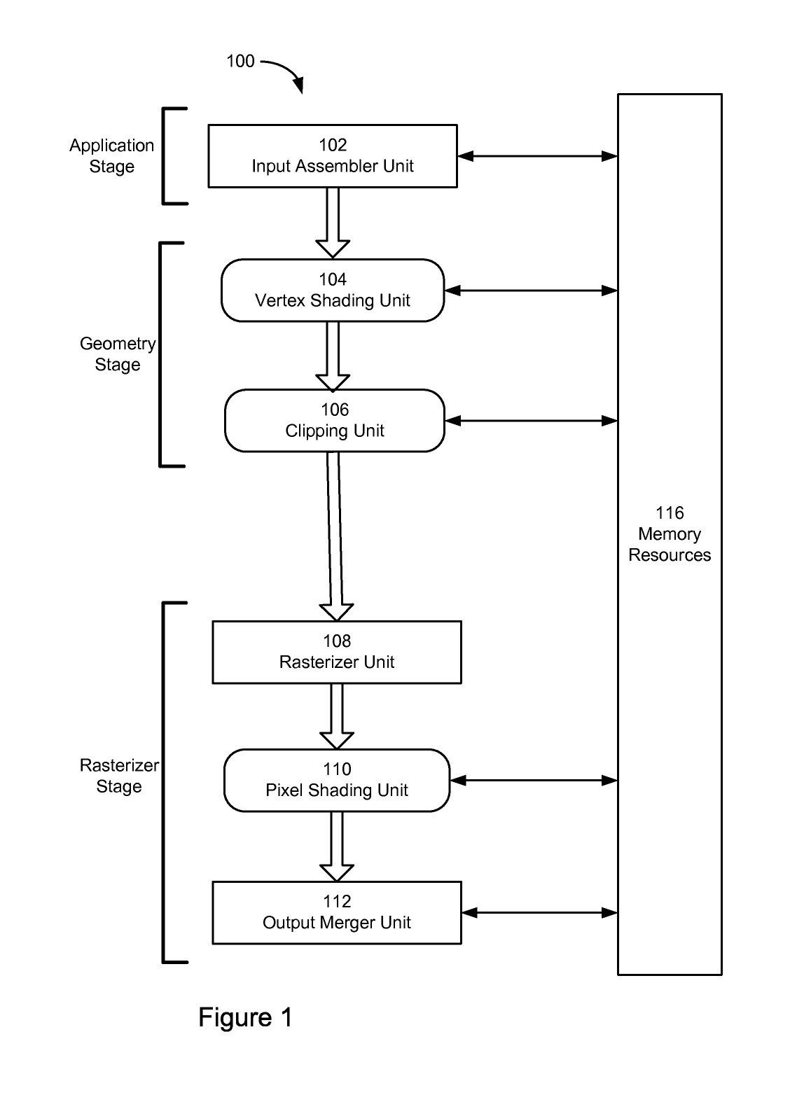

FIG. 1 illustrates a simplified functional breakdown of a graphics pipeline 100, as may be implemented in a graphics processing entity such as a graphics card, a GPU or a gaming console. The graphics pipeline 100 is operative to generate (or render) a two-dimensional (2D) image on a basis of at least one model, thereby simulating a three-dimensional (3D) scene, as may be required by interactive computer graphics applications such as video games or animated movies. The at least one model may be any type of representation of, or information about, the 3D scene, including data, a virtual camera, 3D objects, light sources, shading operations and textures, among many more possibilities. When rendering the 2D image, the shapes and locations of objects in the image are determined by their geometry, the characteristics of the environment and the placement of the camera in that environment, while the appearance of the objects is affected by material properties, light sources, textures and shading models.

In FIG. 1, various functional units of the three different stages (application stage, geometry stage and rasterizer stage) of a typical graphics pipeline 100 are shown. Each such functional unit performs a particular task in the graphics pipeline 100, where these tasks are broken down such as to allow for parallel processing by the processing resources available to the graphics pipeline 100, as will be discussed in further detail below. It is important to note that the units shown in the graphics pipeline 100 of FIG. 1 are merely exemplary and are presented for illustrative purposes only. In other embodiments, additional or different functional units (with varying tasks) may also be included in the graphics pipeline 100, one or more of the units shown in FIG. 1 may be omitted and/or certain functionality represented in FIG. 1 may take a different form.

The memory resources 116 provide for temporary or constant storage of data required by and/or generated by the various stages of the graphics pipeline 100, including for example data buffers, frame buffers, texture buffers, caches, etc. Note that, although in FIG. 1 the memory resources 116 are illustrated simply as a single memory block, the memory resources 116 may include or be divided between several distinct modules or components with any degree of interrelation, depending on the architecture and implementation of the graphics pipeline 100.

In the application stage, an input assembler unit 102 receives instructions from a computer graphics application running on a CPU, such as an interactive computer aided design (CAD) application or a video game application, where this application is developer controlled. In addition to application-driven instructions, the input assembler unit 102 may also receive inputs from one or more other sources, such as a keyboard, a mouse, a head-mounted helmet, a controller, a joystick, etc. The input assembler unit 102 processes all of these instructions and inputs, and generates rendering primitives that represent the geometry of the 3D scene, where these rendering primitives are simple two-dimensional geometric objects that are simple to draw and store in memory, such as points, lines, triangles and polygons.

In the geometry stage, a vertex shading unit 104 and a clipping unit 106 process the rendering primitives and perform per-polygon and per-vertex operations. The vertex shading unit 104 is operative to modify the polygon vertices on a per-vertex basis in order to apply effects to the image to be rendered. The objective is to render the appearance of the objects in the image, which is just as important as the more basic shape and position of the objects. This appearance may include how the color and brightness of a surface varies with lighting (shading), surface detail (texture mapping), surface bumpiness (bump-mapping), reflection, transparency, fogging, blurriness due to high-speed motion (motion blur), among many other possibilities. In a specific, non-limiting example, the vertex shading unit 104 computes shading equations at various points on an object in order to model the effect of a light on a material of the object, where the data that is needed to compute a shading equation may be stored at each vertex and may include the point's location, a normal or a color, among other possible numerical information. The vertex shading unit 104 generates and outputs vertex shading results, which can be colors, vectors, texture coordinates or any other kind of appearance data.

When rendering an image, the clipping unit 106 determines which primitives lie completely inside the volume of the view to be rendered, which primitives are entirely outside the view volume and which primitives are partially inside the view volume. Only those primitives that are wholly or partially inside the view volume are needed for further processing, which may include transmission to the rasterizer stage for drawing on a screen or display. The clipping unit 106 is operative to process the primitives that lie partially inside the view volume and to clip these primitives on the basis of predefined or user-defined clipping planes of the view volume. This clipping operation includes, for example, replacing the vertex of a primitive that is outside of the view volume with at least one new vertex that is located at an appropriate intersection between the primitive and the view volume.

In the rasterizer stage, a rasterizer unit 108, a pixel shading unit 110 and an output merger unit 112 process the transformed vertices and their associated shading data (as output by the geometry stage) for computing and setting colors for the discrete pixels covering an object. This process, also known as rasterization or scan conversion, converts the two-dimensional vertices into pixels on a screen or display. The rasterizer unit 108 is operative to compute differentials and other data for the surface of each triangle, which is used for scan conversion and for interpolation of various shading data generated by the geometry stage. The rasterizer unit 108 also performs triangle transversal, which is the process of determining which pixels have their center (or a sample) covered by each triangle and generating triangle fragments, with the properties of each triangle fragment being generated with data interpolated from the three respective triangle vertices.

The pixel shading unit 110 performs per-pixel shading computations on the basis of interpolated shading data to add effects such as lighting or translucence, thereby generating one or more colors per-pixel to be passed on to the next functional unit of the graphics pipeline 100, notably the output merger unit 112. Note that a plurality of different “shading” techniques may be implemented by the pixel shading unit 110.

The output merger unit 112 is operative to finalize the color of each pixel and to resolve visibility on a basis of the camera view. More specifically, the information for each pixel of the image being rendered is stored in a color buffer, and the output merger unit 112 merges the fragment color generated by the rasterizer unit 108 with the color stored in the color buffer. Furthermore, the output merger unit 112 ensures that, once the image has been rendered, the color buffer only contains the colors of the primitives in the image that are visible from the point of view of the camera. As is well known to those skilled in the art, a Z-buffer (also referred to as a depth buffer) is typically used by graphics hardware to resolve visibility of a rendered image. During image rendering, the Z-buffer stores for each pixel of the color buffer the z-value (or depth) from the camera to the currently closest primitive. It should be noted that various other mechanisms may also be used to filter and capture fragment information, including for example the alpha channel, the stencil buffer and the frame buffer.

Thus, once the rendering primitives have passed through all of the stages of the graphics pipeline 100, those that are visible from the point of view of the camera are displayed on a screen or display. More specifically, the screen or display displays the contents of the color buffer.

As discussed above, the processing performed by the various stages and functional units of the graphics pipeline 100 is implemented by a plurality of processing and memory resources that are available to the graphics pipeline 100, where the processing resources may include software, hardware and/or firmware components of the graphics processing entity containing the graphics pipeline 100, as well as of other remote processing entities, within one piece of equipment or distributed among various different pieces of equipment. Examples of possible processing resources available to the graphics pipeline 100 may include pixel shaders, vertex shaders, geometry shaders and universal shaders, among other possibilities. Each such shader may be a program or function that is executed on a graphics processing unit. A pixel shader computes color and other attributes (e.g. bump mapping, shadows, translucency, depth, etc.) of each pixel. A vertex shader operates on each vertex of an object, manipulating properties such as position, color and texture coordinate in order to transform each vertex's 3D position in virtual space to the 2D coordinate at which it appears on a screen or display. A geometry shader can generate new primitives from the rendering primitives output by the application stage of the graphics pipeline 100, for purposes of geometry tessellation, shadow volume extrusion, mesh complexity modification, etc. A universal shader is a processing resource that is capable to perform various shading operations (e.g. per-pixel computations, per-vertex computations, per-polygon/object computations) and that can be flexibly assigned to a variable function (such as different types of shading operations). Accordingly, a universal shader may implement the functionality of, and thus serve as, two or more of the pixel shaders, vertex shaders and geometry shaders available to the graphics pipeline 100.

The stages of the graphics pipeline 100 (application stage, geometry stage and rasterizer stage) are executed simultaneously with each other, in keeping with the “parallelized” concept of a pipeline architecture. Each of these stages may itself be parallelized, as determined by the implementation of the graphics system. The functional units of each stage of the graphics pipeline 100, such as those shown in FIG. 1, each perform a particular task; however, these tasks may also be implemented in different ways within the graphics pipeline 100. For example, a particular task may be combined with one or more other tasks within a pipeline stage, divided into several pipeline stages or be itself parallelized. Advantageously, this pipelined or parallelized approach to the construction and execution of the graphics pipeline 100 allows for a high performance by the graphics pipeline 100, which is typically demanded by 3D computer graphics applications.

For further information on the functionality and implementation of a standard graphics pipeline, the reader is invited to consult “Real-Time Rendering, Third Edition”, by Tomas Akenine-Möller, Eric Haines and Naty Hoffman, A K Peters, Ltd., 2008, which is hereby incorporated by reference.

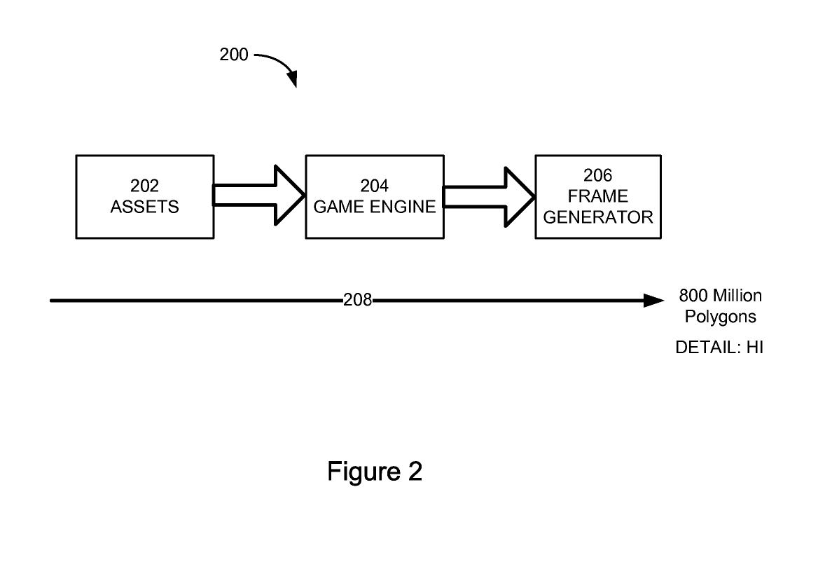

FIG. 2 illustrates traditional 2D image generation in the exemplary context of video gaming, where the CGI of a video game application must generate a 2D view on the basis of one particular view point (also referred to herein as the “camera location”). In this example, the graphics pipeline 200 of a graphics processor in the gaming console is conceptually represented by the relationship between assets 202, a game engine 204 and a frame generator 206. More specifically, assets 202 are any type of model or representation of a 3D scene input to the graphics pipeline 200, such as for example a library of 3D objects in a virtual world. The game engine 205 and frame generator 206 together implement the tasks of the application, geometry and rasterizer stages of the graphics pipeline 200. Thus, using the assets 202 and knowledge of the position and orientation of the virtual “camera” viewing the virtual world, the game engine 204 generates a 2D view 208. The frame generator 206 generates and outputs a single stream of image frames on the basis of this 2D view. In the course of rendering the 2D view, the processing resources available to the graphics pipeline 200 allow for the generation of a maximum number of polygons at the operational frame rate and resolution, which in this specific, non-limiting example is 800 million polygons, which may be considered to correspond to a high level of detail in the rendered image. Note that the number of polygons that may be drawn by a graphics pipeline at its operational frame rate and resolution depends on the available processing resources and, as such, may vary significantly from one implementation of a graphics pipeline to another.

As mentioned above, a stereoscopic viewing mode is becoming an important feature in simulated 3D graphic applications. However, in order for a standard graphics pipeline to provide a stereoscopic viewing mode, the pipeline must be configured to generate two images, or more specifically a dual stream of image frames. It is also possible that a non-stereoscopic application may require that the graphics pipeline be able to generate two streams and thus support a dual viewing mode. For example, screen sharing (or split-screen) multi-player video games require a dual viewing mode in which two different views are generated by the graphics pipeline. In another example, a television in 3D mode requires a dual stream input, where the graphics pipeline may generate either a pair of stereoscopic streams (left and right views) for a stereoscopic viewing experience (with appropriate stereoscopic glasses) or a pair of identical 2D image streams (same view) for a normal viewing mode (without the specialized glasses).

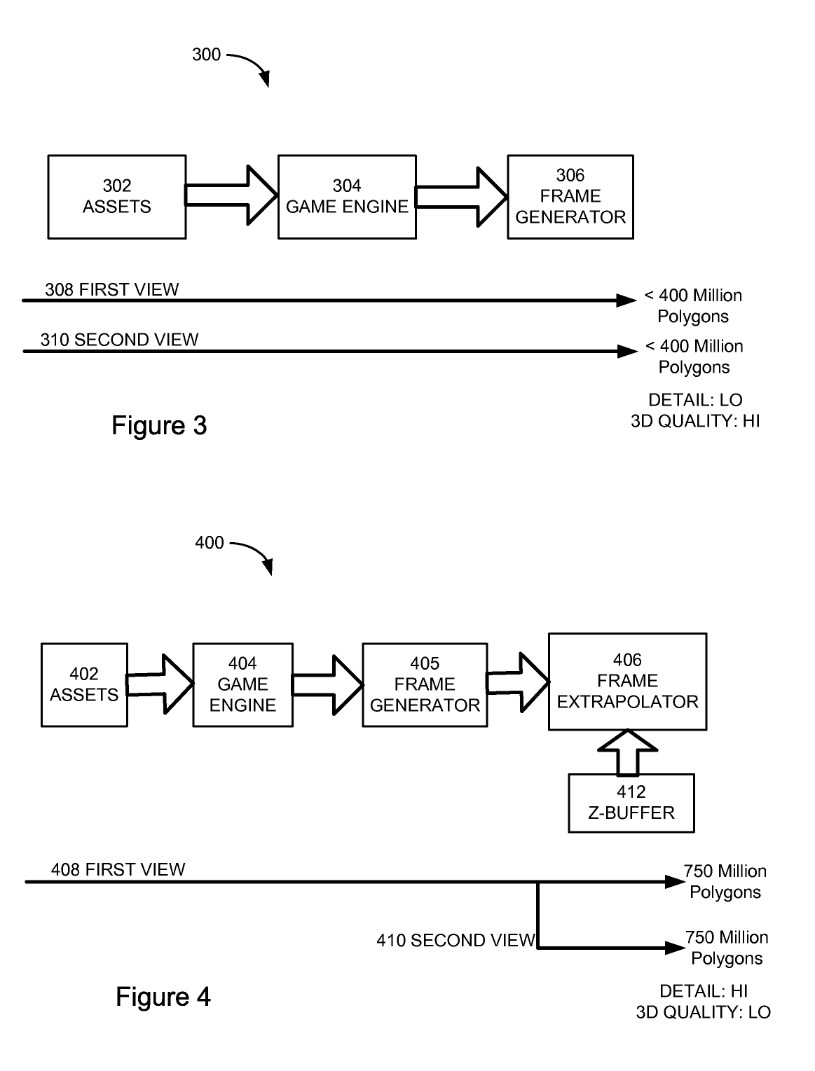

In one possible configuration, a graphics pipeline may be configured to generate two 2D views, and thus two streams of frames, by splitting the available processing resources between the generation of the first view and the generation of the second view, as illustrated conceptually in FIG. 3. Similar to FIG. 2, in FIG. 3 the graphics pipeline 300 of a graphics processor in the gaming console is conceptually represented by the relationship between assets 302, a game engine 304 and a frame generator 306. In this particular configuration, the game engine 304 and frame generator 306 of the graphics pipeline 300 generate a first view 308 and a second view 310, which requires generating twice as many frames (i.e. rendering twice as many pixels). This necessarily requires a reduction of the complexity of the rendering computations (i.e. a reduction of the number of polygons drawn per 2D view) and/or of the frame rate, due to the limited processing capability of the processing resources available to the graphics pipeline 300.

In one possible scenario, the frame rate of the graphics pipeline 300 is reduced by half (as compared to the frame rate of graphics pipeline 200), in which case the number of polygons drawn for each of the two views 308, 310 may remain the same as for a single 2D view.

In another possible scenario, it is possible to maintain the frame rate of the graphics pipeline 300 (at the same rate as for a single 2D view) by significantly reducing the complexity of the rendering computations performed per view. In theory, in order to render each one of the two views 308, 310, the split processing resources should allow for the generation of a maximum of half the polygons that would be used to generate a single 2D view. In a specific example, we can assume that the available processing resources, operational frame rate and resolution are the same as for the graphics pipeline 200 of FIG. 2, in which case the graphics pipeline 300 can generate a maximum of 400 million polygons per view, which may be considered to correspond to a low level of detail in the rendered image. In practice however, the first and second views 308, 310 may have less than half the total number of polygons generated for a single 2D view, due to duplicated per-frame overhead costs within the graphics pipeline 300. Since the processing resources of the graphics pipeline 300 are not necessarily fully reassignable or interchangeable, depending on the architecture of the pipeline 300, it may not be possible to perfectly distribute or split these resources between the two views 308, 310. Accordingly, the graphics pipeline 300 may render each of the first and second views 308, 310 with exactly half the number of polygons drawn for a single 2D view only in the case of perfect resource redistribution within the pipeline 300.

Note that, in the case of a stereoscopic viewing mode, the first and second views 308, 310 correspond to left and right views, rendered on the basis of respective left and right view points of the “virtual camera”.

The result of the graphics pipeline 300 configuration shown in FIG. 3 is a lower level of detail (fewer polygons drawn) in the rendered views. However, in the case of a stereoscopic viewing mode, the quality of the stereoscopy (also referred to herein as 3D quality) will be comparatively high, since each object in the left and right views 308, 310 is specifically drawn from asset data for the left and right eye perspectives. Assuming that the left and right “camera positions” used to draw the left and right images are the correct ones, each object can be drawn at the appropriate angle and position (though with fewer polygons) for stereoscopy, resulting in realistic depth perception for the viewer.

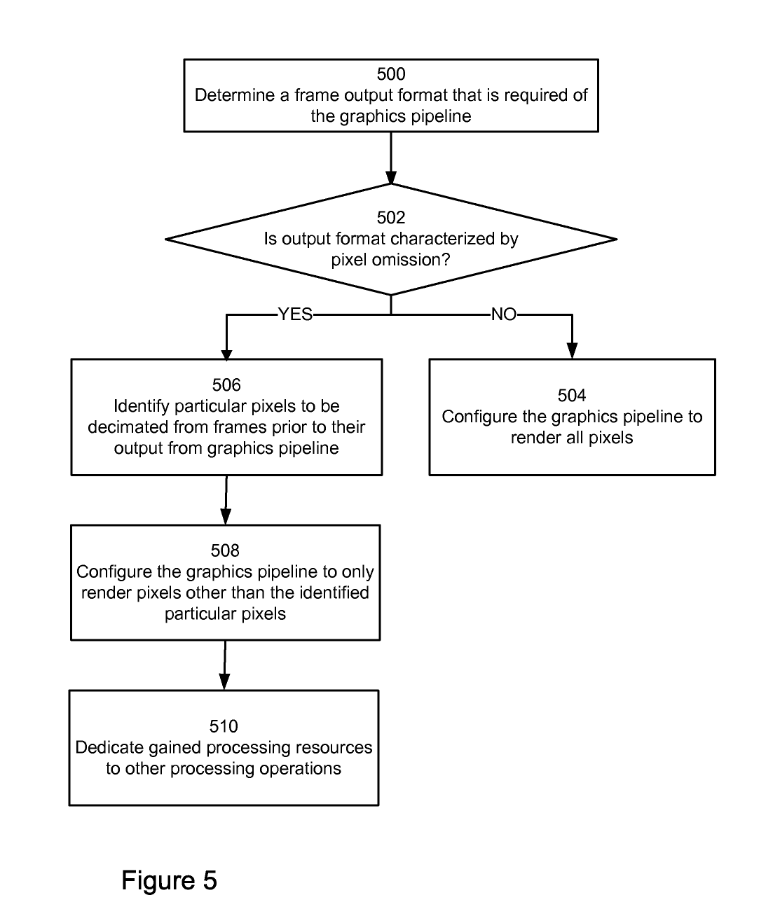

In another possible configuration, illustrated conceptually in FIG. 4, a graphics pipeline may be configured to generate two 2D views, and thus two streams of frames, by taking advantage of the fact that in the generation of 2D images from 3D graphic models, a z-buffer stores depth information for each pixel. Normally, this information is used to determine which polygons are at the front most positions of a rendered view, such as to know which polygons to draw and which to exclude as occluded. However, depth information can also be used as a depth map, which can be used to distort a first rendered view in order to create a second image view. Taking for example left and right stereoscopic views, if the “camera” (viewpoint) position is displaced from the current (left eye) position to a right eye position a known vector away, the relative displacement of each object resulting from moving the viewpoint can be computed if the depth of the object in the scene is known. Thus, a right image frame can be generated from a left image frame using only the left image frame and the information in the z-buffer.

In the example of FIG. 4, the graphics pipeline 400 of a graphics processor in the gaming console is conceptually represented by the relationship between assets 402, a game engine 404, a frame generator 405 and a frame extrapolator 406. In this particular configuration, a first image frame (of the first view 408) is drawn entirely according to the standard 2D process (implemented by the game engine 404 and frame generator 405) and a second frame (of the second view 410) is then extrapolated using the frame extrapolator 406, which has access to the information in the z-buffer 412. Advantageously, this solution can output a first frame at almost the same high level of detail as standard 2D image generation—for example with 750 million polygons drawn (a slightly lowered performance than that in the example of FIG. 2 is explained by the additional processing resource usage by the frame extrapolator 406). The second frame is extrapolated from the first frame and thus comprises a similar level of detail.

However, in the case of a stereoscopic application where the first and second views 408, 410 are in fact left and right views, the 3D quality resulting from the graphics pipeline configuration shown in FIG. 4 may be diminished. In particular, objects in a left frame are not only translated when viewed from a right eye perspective, but may also be rotated such that their surface appears deformed. Furthermore, some portions of the object (for example, near the object's left and right edges) will be occluded from one view but not the other, and vice versa. This makes a perfect recreation of one of views from the other impossible, resulting in imperfect parallax and thus a significantly lower stereoscopic quality than that of the graphics pipeline configuration of FIG. 3.

It is possible to optimize resource usage in a graphics pipeline, such as the exemplary graphics pipeline 100 shown in FIG. 1, by preventing processing resources of the graphics pipeline from performing unnecessary rendering operations. More specifically, if the format in which frames will be output from the graphics pipeline (also referred to herein as an “output format” or an “output frame format”) is one that is characterized by pixel omission, then certain pixels will necessarily be omitted or removed from the frames before the frames are output from the graphics pipeline. This type of output frame format can be detected or determined by the graphics pipeline (if such detection/determination is necessary), the particular pixels that will be removed from the frames before their output can be identified and the graphics pipeline configured to only render pixels other than those particular pixels.

Advantageously, by eliminating unnecessary pixel rendering operations, the work done by the graphics pipeline can be significantly reduced and the processing resources of the graphics pipeline may be freed up and dedicated to other processing operations, which allows the graphics pipeline to overcome the limitations of its inherent parameter trade-offs and to meet the increased performance needs of more complex graphics applications, such as a dual stream viewing mode for a video game application.

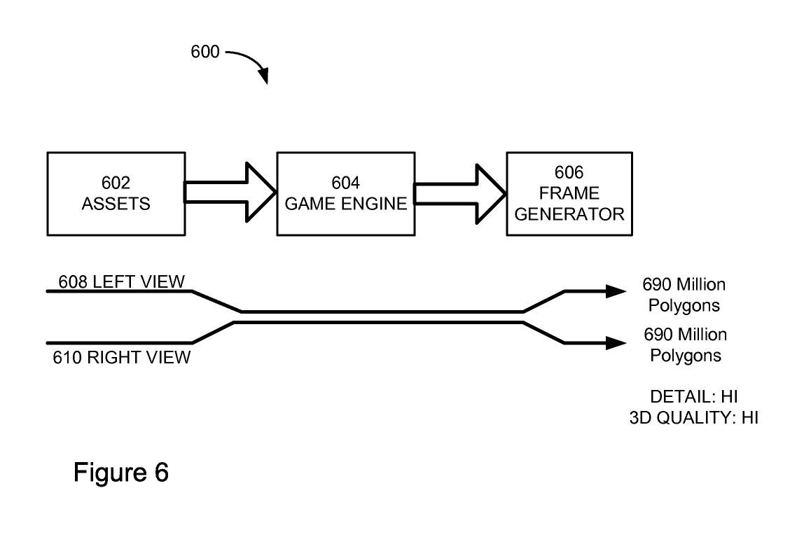

FIG. 5 is a flow diagram illustrating the process implemented by a graphics processing entity, according to a non-limiting embodiment. At step 500, the graphics processing entity determines the format in which frames are to be output from its graphics pipeline. If this frame output format required of the graphics pipeline is characterized by pixel omission at step 502, the graphics processing entity identifies the particular pixels that are to be decimated from each frame prior to its output from the graphics pipeline at step 506. At step 508, the graphics pipeline is configured to only render pixels other than the particular pixels identified at step 506 and, at step 510, the processing resources gained by this reduction in pixel rendering operations are dedicated to other processing operations of the graphics pipeline. Note that, since it is possible that the frame output format required of the graphics pipeline may change from a format that is characterized by pixel omission to one that is not, depending for example on the particular application supported by the graphics pipeline or the type of viewing mode selected by a user, at step 504 the graphics pipeline is configured to render all pixels as per standard 2D image generation.

Note that various different output frame formats characterized by pixel omission are possible and may be accounted for by the graphics pipeline. One such output frame format is a merged frame format, in which the pixels of a pair of frames are reduced by half in number (for example by checkerboard, line or column decimation), compressed and merged together into a single frame. The resulting merged frame format may be, for example, quincunx format, side-by-side format or above-below format. Such a merged frame format may be used for example for outputting dual image streams, such as stereoscopic left and right streams, or alternatively, for outputting a single image stream, in which case pairs of time-successive frames are subsampled, compressed and merged together. Other possibilities of an output frame format with pixel omission may include field interlaced format, line interleaved format and column interleaved format, among other possibilities. In yet another possibility, the output frame format may be a non-merged format, wherein image frames are output with black holes in place of the decimated pixels. In the case of a dual viewing mode, for example, the graphics pipeline would output two separate streams of image frames with black holes.

It is therefore possible that either step 500 or step 506 of the process shown in FIG. 5 may include a sub-step of determining a specific type of frame output format that is required of the graphics pipeline. For example, if the frame output format has been determined at step 500 to be a merged frame format, the process may also include identifying which specific type of merged frame format is required (e.g. quincunx format, side-by-side format or above-below format). The identification of the specific type of merged frame format that is required allows for the identification of the particular pixel decimation scheme that is to be applied to the frames before their output from the graphics pipeline (and thus of which specific pixels are to be decimated from each frame).

Note that, in different embodiments, one or more of steps 500, 502 and 504 may be omitted from the process implemented by the graphics processing entity and shown in FIG. 5. More specifically, the step of determining the frame output format that is used by the graphics pipeline, and thus the step of determining whether or not the output format is characterized by pixel omission, may be unnecessary in a situation where the system is configured (e.g. hardwired) for, and thus only supports, a specific type of frame output format characterized by pixel omission (e.g. quincunx frame output format).

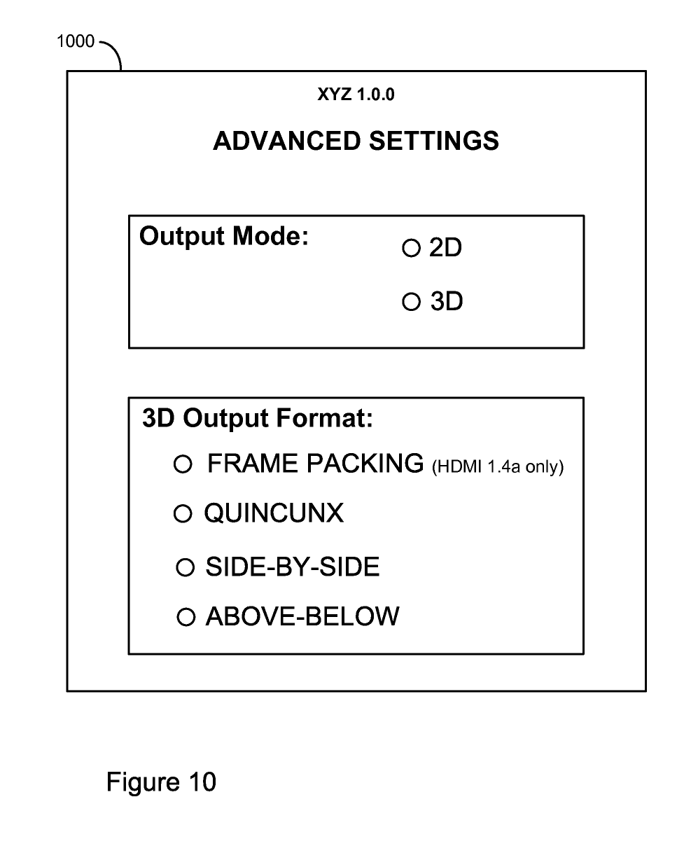

Determination by the graphics processing entity of the frame format in which frames are to be output from its graphics pipeline may be effected by receipt of, or a request for, an application-driven instruction or a user input. Alternatively, this determination may arise as a result of application-driven programming or hard-wiring of the processing resources of the pipeline, among many other possibilities. In a specific, non-limiting example of determination of the frame format by receipt of user input to the graphics processing entity, a graphical user interface (GUI) may be displayed on screen to a user of a video game application, where the display of this graphical user interface may be performed automatically by the application or requested by the user. FIG. 10 illustrates an exemplary graphical user interface 1000 that may be used to allow a user to submit information (i.e. input data or instructions) to the graphics processing entity. In this non-limiting example, the user may select between a 2D and a 3D output mode (for the graphics card) and, if a 3D output mode is selected by the user, the user may also select an output format (in this example, one of a frame packing format, a quincunx format, a side-by-side format and an above-below format). The GUI 1000 provides a plurality of clickable controls that can be activated or selected by the user with a user-controllable pointing device (e.g. a mouse, a trackpad or touchpad, a click wheel, etc.). Various other, different types of user-activatable controls are also possible, including for example drop-down lists. Each control of the GUI 1000 may be in an active or a deactivated state, where in the active state the control is selectable by the user and in the deactivated state the control is unavailable for selection by the user. In the particular example shown in FIG. 10, the controls related to the selection of the output format only become active if and when the user selects a 3D output mode. Note that the GUI shown in FIG. 10 is for illustration only and may vary greatly both in layout and content, depending on the particular application and/or the architecture/design/capability of the graphics processing entity.

Furthermore, for each different output frame format, different pixels of a frame are targeted for pixel decimation during subsampling. The pixels to be decimated may be pixels at specific locations, either random or in a pattern (e.g. a checkerboard pattern), one or more lines of pixels or one or more columns of pixels. Once the output frame format that is required of the graphics pipeline is determined as being one that is characterized by pixel omission, the particular pixels in each frame that are going to be decimated are identified and data representative of this pixel identification (e.g. specific pixel locations by row and column, complete lines of a frame or complete columns of a frame) is used by the graphics processing entity implementing the graphics pipeline to control which pixels are actually rendered by the processing resources available to the graphic pipeline.

Regardless of the type of output frame format, the associated characteristic pixel omission, which may be for purposes of equipment and/or communication compatibility, transport bandwidth savings or storage space savings, among other possibilities, can consist of the removal of any number of pixels from the frames prior to their output from the graphics pipeline, including for example half the total number of pixels in each frame. Accordingly, the number of pixels actually rendered per frame by the processing resources of the graphics pipeline is dependent on the particular output frame format required of the graphics pipeline.

As discussed above, the frame rate, resolution and level of detail (number of polygons processed per frame) supported by a graphics pipeline are generally related in that, for a given amount of processing resources, if one of these parameters increases, it is generally at a cost to the others. However, since the usage of these processing resources by the graphics pipeline is dependent on the total number of pixels to be rendered per frame, reducing the number of pixels to be rendered per frame allows for such tradeoffs to be at least partly overcome. More specifically, by decreasing the usage of processing resources for pixel rendering operations, it is possible to use the gain in processing resource availability to increase the number of polygons drawn per pixel, and thus increase the level of detail supported by the graphics pipeline (while maintaining constant the resolution and frame rate). Alternatively, for a constant resolution and level of detail, it is possible to use the gain in processing resource availability to increase the frame rate supported by the graphics pipeline.

In a specific, non-limiting example of implementation, consider the case of an Xbox® 360 gaming console, which does not support HDMI 1.4a (a high-definition multimedia interface that defines two mandatory 3D formats for broadcast, game and movie content) and cannot output in frame packing format (where full resolution left and right frames are provided). If a stereoscopic viewing mode is required, stereoscopic frame sequences are output from the graphics pipeline of the gaming console in a merged frame format, where only half the pixels for each frame are kept. By detecting this type of frame output format and configuring the graphics pipeline of the gaming console to only render the pixels that will be kept at the time of output, a lot of processing burden is lifted from the graphics pipeline and thus from its processing resources. These processing resources can then be used to draw additional polygons per frame when rendering the view, thus increasing the level of detail in the rendered images displayed on screen to a user of the Xbox®.

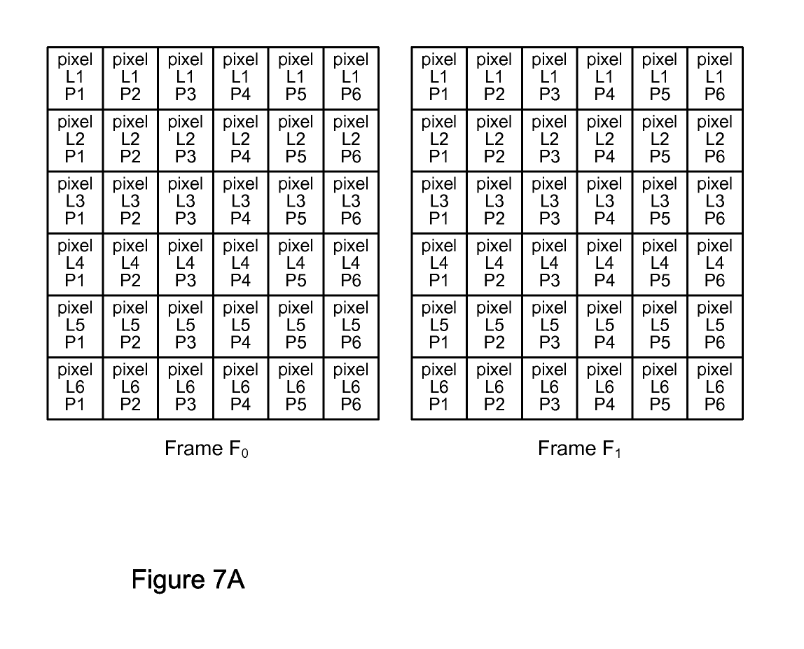

FIG. 6 illustrates an image generation system for rendering two-dimensional images, in accordance with a non-limiting embodiment. In a specific example, assume that the CGI of a video game application must support a dual viewing mode, (each 2D view generated on the basis of a particular camera viewpoint, where the same or different viewpoints may be used for the two views) and the required output frame format is a merged frame format (in which only half of the pixels of each frame are kept). Note that, although this example is based on the use of a merged frame format by the image generation system, the described techniques/processes may in fact be used for any transmission/storage format in which pixels are omitted, removed or decimated from a frame (e.g. according to a pixel decimation/omission/removal pattern).

In FIG. 6, the graphics pipeline 600 of a graphics processor in the gaming console is conceptually represented by the relationship between assets 602, a game engine 604 and a frame generator 606. As in the example of FIG. 2, assets 602 are any model or type of representation of a 3D scene that is input to the graphics pipeline 600. The game engine 604 and the frame generator 606 together implement the tasks of the application, geometry and rasterizer stages of the pipeline 600. Thus, using the assets 602 and knowledge of the positions and orientations of the virtual “camera” viewing the virtual world, the game engine 604 is operative to generate first and second views 608, 610. The frame generator 606 generates a dual stream of image frames on the basis of these 2D views 608, 610, where this dual stream of image frames may be output from the graphics pipeline 600 in the form of a single stream of merged frames or a pair of streams, for example for transmission to a display or a screen, for transport to a remote entity or for storage.

Note that each of conceptual graphics pipelines 200, 300, 400, 600 may be realized functionally by the graphics pipeline 100, where the functionality of the various stages (application, geometry, rasterizer) and units (input assembler unit 102, vertex shading unit 104, clipping unit 106, rasterizer unit 108, pixel shading unit 110, output merger unit 112, etc.) of the graphics pipeline 100 may be adapted to the particular configuration of a respective one of conceptual graphics pipelines 200, 300, 400, 600.

In the example of FIG. 6, since the output frame format is one in which half of the pixels of each frame are decimated, the graphics pipeline 600 is operative to only render those pixels that will not be removed from the frame during subsampling prior to output, which lowers the processing burden of rendering a single frame and allows for an increase in the number of polygons drawn per pixel of each frame. Advantageously, by not wasting processing resources on the rendering of pixels that are to be decimated at subsampling, it is possible to achieve significant optimization of resource usage by the graphics pipeline 600, as compared to a graphics pipeline in which all pixels are rendered for each frame and then half of these rendered pixels are decimated upon subsampling and frame merging. This optimization of resource usage by the graphics pipeline 600, which includes savings in processing time spent by various resources on their respective tasks or operations and which may lead to increased availability of these processing resources for the same or different operations, allows for an improved performance by the graphics pipeline 600 and thus a greater flexibility to use the pipeline 600 for applications of increasing complexity. Thus, as shown in FIG. 6, in the course of rendering the frames of first and second views 608, 610, the processing resources available to the graphics pipeline 600 are able to draw a relatively high number of polygons at the operational frame rate and resolution, for example 690 million polygons. The result is a pair of rendered 2D views 608, 610 that have a high level of detail due to the high number of polygons and, in the case where views 608 and 610 are left and right stereoscopic views, a high level of 3D quality, since both images are drawn from scratch, rather than inferring one from the other.

Note that it is also possible to apply this technique of only drawing non-decimated pixels to a graphics pipeline that generates two image views by inferring one view from another view (e.g. using the Z-buffer), such as in the exemplary case of the graphics pipeline 400 of FIG. 4. Since less pixels need to be rendered by the graphics pipeline per frame, the available processing resources (e.g. the resources used by game engine 404, frame generator 405 and frame extrapolator 406 of graphics pipeline 400) are able to draw a higher number of polygons and thus render a pair of 2D views with an even higher level of detail (than when rendered by drawing all of the pixels, including those that are to be decimated per the output frame format). However, in the case of stereoscopic views, the level of 3D quality may suffer as a result of inferring one view from another.

Given the different stages of the graphics pipeline 600, as well as the various different functional units of each stage of the graphics pipeline 600, the above-described novel method of optimizing resource usage within the graphics pipeline may have different impacts on each different stage, as well as on each different functional unit (or specific task or operation) of the graphics pipeline. More specifically, the general concept of reducing the number of pixels rendered by the graphics pipeline 600, and thus reducing the associated processing or computational burden, may be realized in different ways across the different modules/operations in the pipeline 600.

For example, if we first consider the rasterizer stage of the graphics pipeline 600, which is responsible for computing and setting colors for the pixels of each frame, a reduction in the number of pixels to be rendered by the graphics pipeline 600 has a direct impact on the resource usage by this stage. More specifically, less pixels to render means less triangle traversal operations, since there are less pixels for which triangle fragments must be generated, and thus less vertex-based interpolation computations to be performed. Furthermore, less pixels to render means less pixel shading operations, as well as less merging operations (e.g. for each pixel, combining fragment color with color stored in color buffer), since there are less pixels for which the color must be set. Also, less pixels to render means less z-values (or depth values) to store in the Z-buffer, and thus less usage of memory resources, as well as less z-value computations and color buffer updates. However, while a reduction by half of the pixels to generate will result in a reduction by half of each of the triangle traversal, pixel shading and merging operations needed to render a frame, the reduction in the operations to resolve visibility will depend on the number and spatial arrangement of the primitives being rendered in the image.

In another example, if we consider the geometry stage of the graphics pipeline 600, which is responsible for the per-polygon and per-vertex operations, a reduction in the number of pixels to be rendered by the graphics pipeline 600 may also have an indirect impact on the resource usage by this stage. Since a particular task of the geometry stage of the graphics pipeline 600 is to perform screen mapping, whereby three-dimensional coordinates of the vertices of each primitive in the rendered view are transformed into screen coordinates for use by the rasterizer stage, and since a specific, pre-defined pixel coordinate system (e.g. Cartesian coordinates) is used by the geometry stage to map integer and floating point values (of the screen coordinates) to pixel coordinates, it is possible to identify ranges of screen coordinate values that correspond to the pixel coordinates of those particular pixels that will be decimated from the frames prior to output and thus are not to be rendered. By applying to these ranges of screen coordinate values a reversal of the screen mapping operations (e.g. translation operations, scaling operations, rotation operations, etc.) that are to be used to transform the three-dimensional coordinates of the vertices of each primitive in the rendered view into screen coordinates, it is possible to identify the specific three-dimensional coordinate ranges in world space that correspond to the pixels to be decimated in the rendered image frame.

With this identification of the specific three-dimensional coordinate ranges in world space that correspond to pixels that are not to be rendered, various operations of the geometry stage may be simplified, thus freeing up processing resources. For example, clipping operations (i.e. vertex replacement operations) may be reduced if, for those primitives that lay partially outside of the view volume, certain of the vertices to be replaced are located within the specific three-dimensional coordinate ranges. Also, vertex shading operations may be reduced, since shading equations need not be computed for those vertices of the modeled object that are located within the specific three-dimensional coordinate ranges. Furthermore, the model and view transformation operations may be reduced, since those operations that transform model vertices onto a three-dimensional co-ordinate position that falls within the specific three-dimensional ranges need not be performed.

Note that the modules and operations of the rasterizer and geometry stages of the graphics pipeline 600, as well as possibly of the application stage, may be affected in many other, different ways, and their processing burden reduced, as a result of the reduction in the number of pixels to render by the graphics pipeline 600, due to the non-rendering of pixels omitted according to a merged frame format. For example, by reducing a resolution (e.g. horizontal, vertical or diagonal resolution), certain vertex computations performed by the geometry stage may be simplified to provide less accurate results, where the loss in accuracy does not affect the visible view quality (i.e. is not apparent to the naked eye).

Another way in which the rendering of a reduced number of pixels by the graphics pipeline 600 may affect the resource usage and performance of the graphics pipeline 600 is that, in many crucial areas of the pipeline 600, less memory resources will be used. For example, the Z-buffer, which stores depth values for each pixel, will only need to store depth values for those pixels that are actually being rendered by the pipeline 600. Similarly, the frame buffer, which stores pixels of a frame for displaying, may be reduced in size. Likewise, internal data transportation resources and memory bandwidth requirements may be reduced.

By saving on resource usage within one or more stages of the graphics pipeline 600, it may be possible to flexibly reassign the gained processing resources within the respective stage to perform different or additional processing burden. For example, insofar as they can be flexibly reassigned, the processing resources applied to the rasterizer stage of the graphics pipeline 600 that are freed up as a result of the non-rendering of decimated pixels may be able to take over certain processing operations of the geometry stage and/or other processing operations of the graphics pipeline 600.

Increasingly, unified shader resources may be used for a graphics pipeline, where these unified shader resources can be assigned to tasks as required, whether these be pixel-based tasks (currently performed by pixel shaders), vertex-based tasks (currently performed by vertex shaders) or geometry tasks (currently performed by geometry shaders). Such unified resources are polyvalent and assignable as required. It is thus important to note that the above discussed processing burden saving measures may equally apply in a context where tasks of the graphics pipeline 600 are performed by unified resources. Indeed, under such conditions, the knowledge that the output of the pipeline 600 is in a subsampled format can be very useful for optimizing resource usage, since shading resources saved for one task can be applied to other tasks. Thus, if for example the rendering of only half the pixels allows for many resources to be saved in the pixel shading operations, the saved resources can be put to use for other tasks, such as vertex shading operations.

In general, however, the graphics pipeline 600 is able to process frames at an increased complexity and/or at an increased frame rate as a result of the identification of pixels to be omitted according to a particular output frame format and the non-rendering of such omitted pixels or, in other words, the rendering of pixels identified as not omitted (either partially or entirely to the exclusion of omitted pixels).

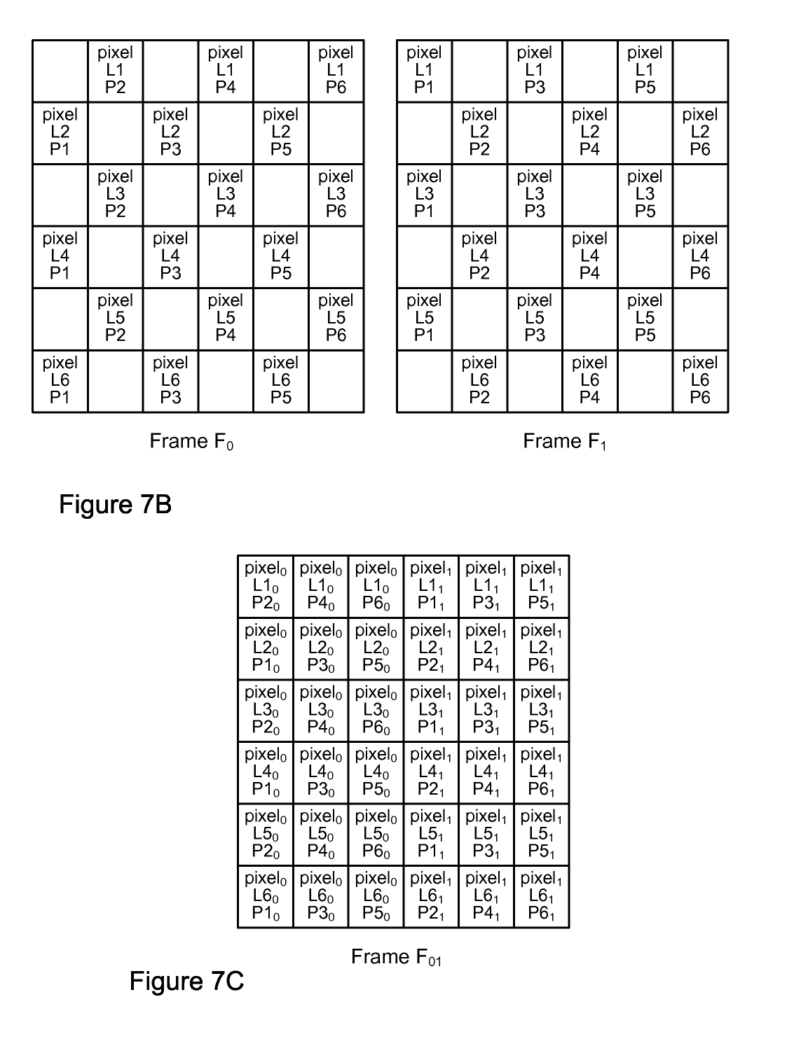

In a specific, non-limiting example of implementation, the graphics pipeline 600 generates stereoscopic left and right streams of frame sequences, which are to be output from the graphics pipeline 600 in a quincunx merged frame format. As disclosed in commonly assigned U.S. Pat. No. 7,580,463, the specification of which is hereby incorporated by reference, stereoscopic image pairs of a stereoscopic video can be compressed by removing (or subsampling) pixels in a checkerboard pattern and then collapsing the checkerboard pattern of pixels horizontally. The two horizontally collapsed images are placed in a side-by-side arrangement within a single standard image frame. At the time of display, this standard image frame is expanded into the checkerboard pattern and the missing pixels are spatially interpolated. FIGS. 7A, 7B and 7C illustrate quincunx sampling and the quincunx merged frame format, where FIG. 7A is an example of a pair of left and right image frames of a stereoscopic dual stream. FIG. 7B illustrates a non-limiting example of sampled frames F₀ and F₁, where, in frame F₀, the even-numbered pixels have been sampled from the odd-numbered lines of the frame (e.g. sampling pixels P2, P4 and P6 from line L1) and the odd-numbered pixels from the even-numbered lines of the frame (e.g. sampling pixels P1, P3 and P5 from line L2). In contrast, in frame F₁, the odd-numbered pixels have been sampled from the odd-numbered lines of the frame (e.g. pixels P1, P3 and P5 from line L1) and the even-numbered pixels from the even-numbered lines of the frame (e.g. pixels P2, P4 and P6 from line L2). Alternatively, both frames F₀, F₁ may be identically sampled according to the same quincunx sampling pattern. Once the frames F₀, F₁ have been sampled, they are collapsed horizontally and placed side by side within new image frame F₀₁, as shown in FIG. 7C. Thus, each one of frames F₀ and F₁ is spatially compressed by 50% by discarding half of the pixels of the respective frame, after which compression the two sampled frames are merged together to create a new image frame F₀₁.

Thus, in the case of the specific, non-limiting example of quincunx subsampling shown in FIG. 7B, rather than generating whole left and right image frames and subsequently applying quincunx decimation, the graphics pipeline 600 may be configured to only render the even pixels of the odd lines and the odd pixels of the even lines for the frames of the left view image stream. Similarly, the graphics pipeline 600 may be configured to only render the odd pixels of the odd lines and the even pixels of the even lines for the frames of the right view image stream. In so doing, the graphics pipeline 600 does not render any pixels that are going to be decimated from the left and right frames prior to output from the graphics pipeline 600.

As discussed above, various different frame output formats in which only half the pixels for each of the left and right frames are kept may also be used by the graphics pipeline 600 when rendering stereoscopic image streams. For example, both the side-by-side merged frame format (in which entire columns of pixels are omitted upon subsampling and frame merging) and the above-below merged frame format (in which entire rows of pixels are omitted upon subsampling and frame merging) may be used by the graphics pipeline 600 to render stereoscopic image streams, whereby the graphics pipeline 600 is configured not to render the pixels of the rows and columns to be omitted or decimated from the frames prior to their output from the pipeline 600. However, it is known from previous studies on the technique of quincunx decimation that quincunx subsampling is virtually visually lossless. As such, a particular advantage of using the quincunx frame output format is that both the visible resolution and the frequency response (horizontal and vertical) of the rendered images can be maintained even with decimation of half of the pixels from each frame. This same advantage applies when using the quincunx frame output format for non-3D stereoscopy to generate quincunx-decimated 2D images using less processing resources of a graphics pipeline, be it for purposes of reduced bandwidth or space transportation/transmission, reduced storage or for immediate display (after interpolating missing pixels) by a screen or display, among other possibilities. Furthermore, since quincunx decimation reduces the diagonal frequency response of an image, the use of a quincunx merged frame format may allow for additional reductions in the processing operations of the geometry stage of the graphics pipeline 600. More specifically, operations that would increase (for example, above a threshold) diagonal high frequencies, such as certain forms of tessellation, or operations to modify certain primitive vertices that are already contributing to insupportably high diagonal frequencies may be omitted.

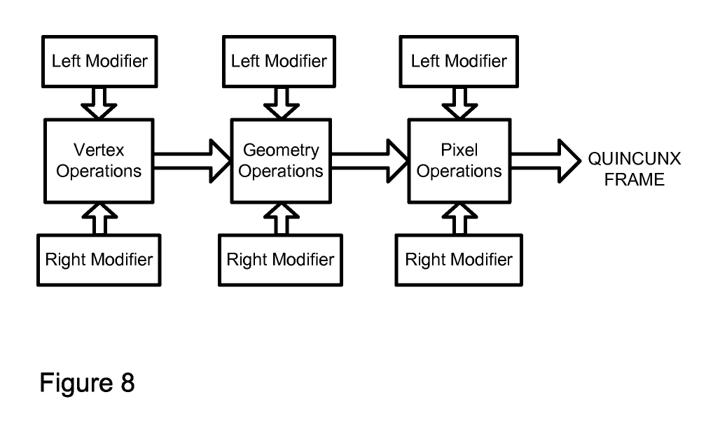

In a variant embodiment, the graphics pipeline 600 may be configured to perform even more efficiently by directly rendering a single stream of merged format frames, rather than rendering two image streams, one for the left view and one for the right view, and later merging the left and right frames. More specifically, as illustrated conceptually in the block diagram of FIG. 8, the graphics pipeline 600 could generate one set of data and a difference or offset for each of the left and right views, the differences/offsets being generated on the basis of predefined left and right modifiers applied to the computations/operations of the graphics pipeline 600. In so doing, a complete quincunx frame that comprises both a left and a right image could be generated in a single pass. It should be noted that various manners of implementing such processing are possible and may be applied by the graphics pipeline 600.

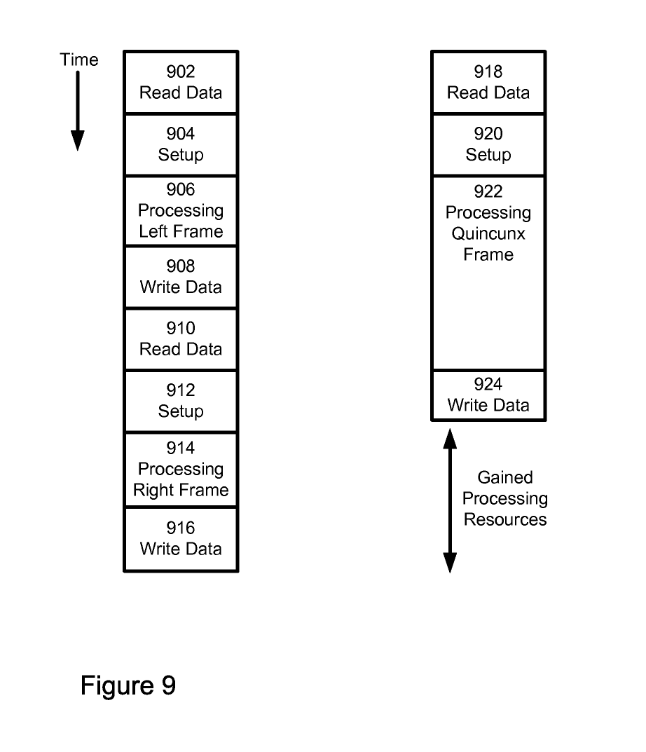

In a highly simplified form, FIG. 9 illustrates a comparison of the operations of a graphics card when directly rendering a single stream of merged format frames and the operations when rendering two separate image streams, one for the left view and one for the right view. As shown, generating a frame involves some overhead in the form of reading (902, 910, 918), writing (908, 916, 924) and setup (904, 912, 920), as well as the processing operations (906, 914, 922). Processing two frames (left and right frames) simultaneously necessarily requires more processing, since two images have to be generated at once. However, since both frames can be output at the same time, there is a significant reduction in the processing burden since only one setup overhead is required per pair of stereoscopic frames.

In the specific, non-limiting example in which the required output frame format required of the graphics pipeline 600 is a merged frame format (in which only half of the pixels of each frame are kept), only one complete frame of the full resolution (containing both left and right images) is generated by the graphics pipeline 600 for every two frames (one left and one right) that would otherwise need to be generated if merged frame encoding was not being used. This can be interpreted as halving the frame rate for a given resolution. It can also be interpreted as halving the resolution for a given effective frame rate, if we consider a merged frame as two frames (one left and one right) of half resolution. Both interpretations correspond to an increase in the resources available for generating an image, as well as a reduction in the overhead resource costs, while the equivalent of more than half of the polygons of a 2D image for each stereoscopic view (e.g. left or right) can be rendered.

It is also important to note that, since some operations (e.g. frame buffering) can be done for two frames (a left and right view) at once, additional processing time is saved. This saved processing time can then be used to render the two images (left and right), which processing time is necessarily greater than that required to render a single image in the frame. The additional gains in processing resource availability may be used to increase the frame rate or to increase the level of detail provided for each of the left and right images to more than half of a traditional 2D frame.

The various functional units, components and modules of the graphics pipeline (100, 300, 400, 600) may all be implemented in software, hardware, firmware or any combination thereof, within one piece of equipment or distributed among various different pieces of equipment. The complete graphics pipeline may be built into one or more graphics processing entities, such as graphics processing units (GPUs) and CPUs. The architecture and/or implementation of the graphics pipeline (100, 300, 400, 600) affects the flexibility of the processing resources used by the graphics pipeline, or more specifically the possibility of saving, reallocating and/or redistributing these resources when there is a reduction in the number of pixels to be rendered by the graphics pipeline or a reduction of the frame rate of the pipeline. For example, if a general purpose processor is used to perform tasks for the rasterizer stage of the graphics pipeline, instruction cycles saved on reduced pixel rendering operations can be easily used by other processes. In another example, a cache can be freed up as a result of reduced pixel rendering, making it available for use by other processing tasks or operations within the pipeline. Various other, different resource sharing/reallocation scenarios are also possible and may be contemplated by the graphics pipeline 600, in dependence on the particular architecture of the graphics pipeline 600. However, the design of a graphics processing unit may also prevent certain resources (that are freed up as a result of reduced pixel rendering) from being re-used. Furthermore, even if the design of the graphics processing unit does allow for certain resources to be re-used, it may not allow for the re-use all of the resource savings, nor may it allow the re-use of the resource savings for just any type of optimization within the pipeline.

Accordingly, the optimization of resource usage that is possible within a graphics pipeline as a result of only rendering non-decimated pixels is dependent on, and may vary on a basis of, the particular architecture and/or implementation of the pipeline.

The memory resources used by the graphics pipeline may be either local to graphic processing entities or remote (e.g. a host memory via bus system), such as in a remote networked system. It should be noted that storage and retrieval to/from the memory resources of pixels, frame lines or columns, vertices, normals, parameters, coordinates, etc. may be done in more than one way. Obviously, various different software, hardware and/or firmware based implementations of the techniques of the described embodiments are also possible.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

What is claimed is:

1. A method of optimizing resource usage in a graphics pipeline, said graphics pipeline operative to render pixels of a two-dimensional image on a basis of at least one model and to output a stream of image frames characterized by an output frame format, a frame rate, a resolution and a level of detail, said method comprising:
a. if said output frame format is characterized by pixel omission:
i. identifying a plurality of pixels removed from said frames prior to their output from said graphics pipeline according to said format;
ii. configuring said graphics pipeline to only render for each frame pixels other than said plurality of pixels.

2. A method as defined in claim 1, wherein said method includes, for a constant resolution, increasing at least one of said frame rate and said level of detail supported by said graphics pipeline.

3. A method as defined in claim 1, wherein said pixel omission is a reduction by half of the total number of pixels in each frame.

4. A method as defined in claim 3, wherein said method further comprises configuring said graphics pipeline to render twice as many pixels and to generate first and second streams of image frames, said first and second streams having first and second levels of detail that are at least half of said level of detail.

5. A method as defined in claim 4, wherein said output frame format is a merged frame format.

6. A method as defined in claim 5, wherein said first and second streams of image frames are stereoscopic video streams and said merged frame format is a quincunx merged frame format, said stream of frames output by said graphics pipeline further characterized by a quality of stereoscopy.

7. A method as defined in claim 1, further comprising determining said output frame format.

8. A method as defined in claim 1, further comprising reassigning at least one processing resource of said graphics pipeline from a pixel rendering-related operation to a different processing operation.

9. An image generation system for rendering two-dimensional images, said system comprising:
a. at least one input for receiving data representative of a three-dimensional scene; and
b. a graphics pipeline operative to process said data and to render pixels of a two-dimensional image, said graphics pipeline outputting a stream of image frames in a particular format and characterized by a frame rate, a resolution and a level of detail;
c. wherein, if said particular format is characterized by pixel omission, said system is operative to:
i. identify a plurality of pixels removed from said frames prior to their output from said graphics pipeline according to said particular format;
ii. configure said graphics pipeline to only render for each frame pixels other than said plurality of pixels.

10. A processing entity for generating a two-dimensional image on a basis of data representative of a three-dimensional scene, said processing entity operative to render pixels of said two-dimensional image and to output a stream of image frames in a particular format, wherein, if said particular format is characterized by pixel omission, said processing entity is further operative to:
a. identify a plurality of pixels removed from said frames prior to their output from said processing entity according to said particular format;
b. only render for each frame pixels other than said plurality of pixels, thereby freeing up resources of said processing entity for other processing operations.

11. A method of generating two-dimensional images for a computer graphics application, said method comprising:
a. receiving data representative of a three-dimensional scene;
b. processing said data for rendering pixels of a two-dimensional image and for outputting a stream of image frames;
c. determining a format in which said frames are output;
d. if said format is characterized by pixel omission:
i. identifying a plurality of pixels removed from said frames prior to their output according to said format;
ii. only rendering for each frame pixels other than said plurality of pixels.

12. A method for outputting a stream of image frames in a merged frame format, the merged frame format being characterized by a merging together of a pair of frames, the merging including omission of a plurality of pixels from each frame, said method comprising:
a. identifying a first plurality of pixels omitted from a first frame and a second plurality of pixels omitted from a second frame according to the merged frame format;
b. selecting first and second sets of pixels to render for the first and second frames, respectively, said first set of pixels excluding said first plurality of pixels, said second set of pixels excluding said second plurality of pixels;
c. generating said first frame by rendering only said first set of pixels and generating said second frame by rendering only said second set of pixels;
d. merging said first and second frames into a third frame on a basis of said merged frame format;
e. outputting said third frame in a stream of image frames.
